(19) United States
(12) Patent Application Publication
(10) Pub. No.: US 2019/0327912 A1
(43) Pub. Date: Oct. 31, 2019

(54) Solar Powered Greenhouse

(71) Applicant: James Varga Tanner, Avon, OH (US)

(72) Inventor: James Varga Tanner, Avon, OH (US)

(21) Appl. No.: 16/397,744

(22) Filed: Apr. 29, 2019

Related U.S. Application Data
(60) Provisional application No. 62/663,663, filed on Apr. 27, 2018.

(51) Int. Cl. A01G 9/24; H02S 40/32; H02S 40/38; H02S 20/22; H02S 40/20; A01G 9/22

(52) U.S. Cl. CPC A01G 9/243; H02S 40/32; H02S 40/38; A01G 9/241; H02S 40/20; A01G 9/22; H02S 20/22

(57) ABSTRACT

A solar powered greenhouse is an apparatus that harnesses electricity from sunlight and manages sunlight exposure with plants housed within the apparatus. The apparatus includes a housing, at least one photovoltaic glass layer, at least one adjustable-opacity panel, a solar inverter, a solar batter, a microcontroller, and a control pad. The housing maintains a desired environment for plants. The at least one photovoltaic glass layer allows sunlight to enter the housing, collecting and converting the sunlight into direct current (DC) electricity. The at least one adjustable-opacity panel controls sunlight entering the housing. The solar inverter converts the DC electricity into alternating current (AC) electricity. The AC electricity is stored with the solar battery. The at least one photovoltaic glass layer, the at least one adjustable-opacity panel, the solar inverter, the solar battery, and the control pad are controlled by the microcontroller and managed by a user with the control pad.

The current application claims a priority to the U.S. Provisional Patent application Ser. No. 62/663,663 filed on Apr. 27, 2018. The current application is filed on Apr. 29, 2019 while Apr. 27, 2019 was on a weekend.

### FIELD OF THE INVENTION

The present invention generally relates to displays. More specifically, the present invention is solar powered greenhouse.

### BACKGROUND OF THE INVENTION

Greenhouses are tremendously helpful in regulating climatic conditions in order to help certain plants grow in an otherwise unideal environment. However, greenhouses also require a decent amount of energy as an upkeep. It is an object of the present invention to address this issue by providing users with a greenhouse with transparent electro-chromatic solar glass designed to accommodate growers who require it to be completely off grid.

### BRIEF DESCRIPTION OF THE DRAWINGS

FIG. 1 is a perspective view of the present invention.

FIG. 2 is a front view of at least one frame integrated within a housing of the present invention.

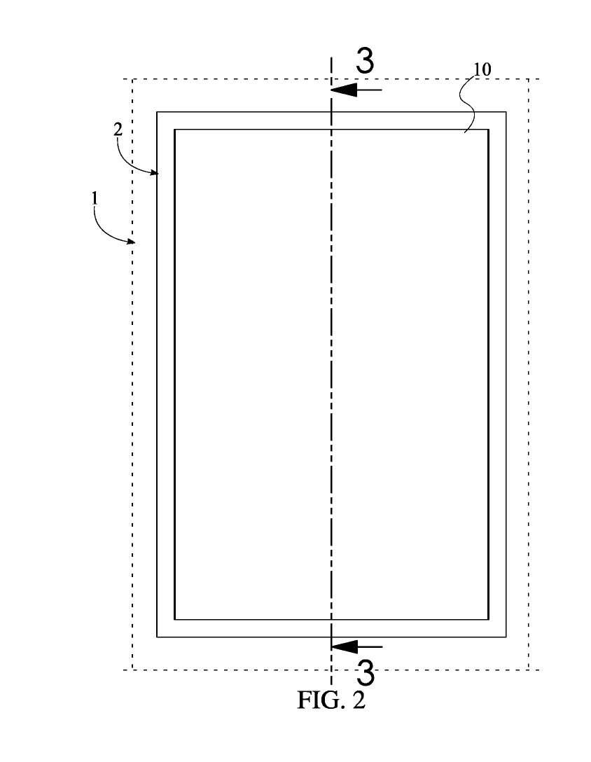

FIG. 3 is a cross-section view FIG. 2 along line 3-3 of the present invention.

FIG. 4 is an exploded view at least one frame, at least one photovoltaic glass layer, at least one adjustable opacity panel, at least one first gasket, and at least one second gasket of the present invention.

FIG. 5 is a schematic view of the electronic connections of the present invention.

FIG. 6 is a schematic view of the electric connections of the present invention.

FIG. 7 is a schematic view of the conversion process of direct current (DC) electricity to alternating current (AC) electricity of the present invention.

### DETAILED DESCRIPTION OF THE INVENTION

All illustrations of the drawings are for the purpose of describing selected versions of the present invention and are not intended to limit the scope of the present invention.

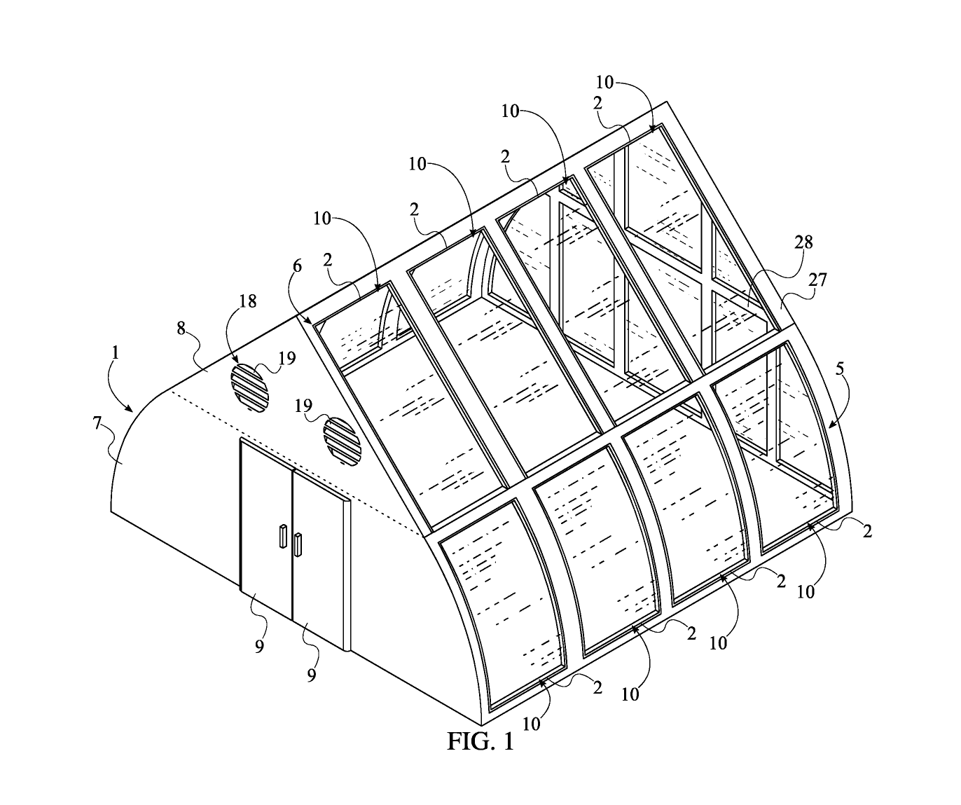

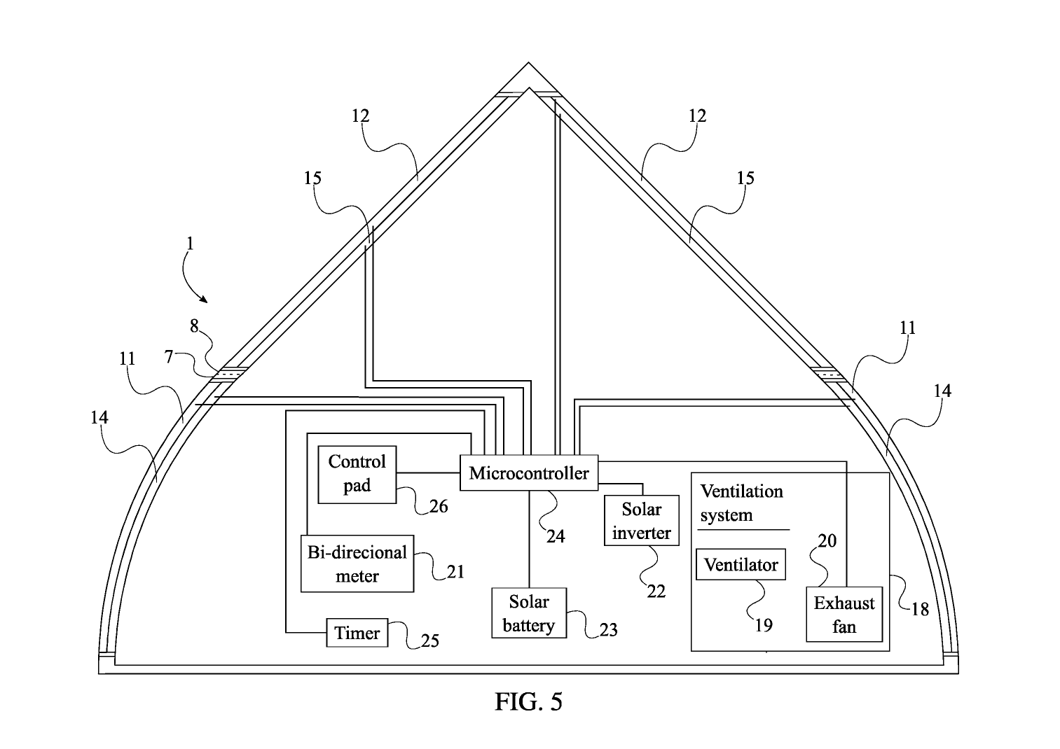

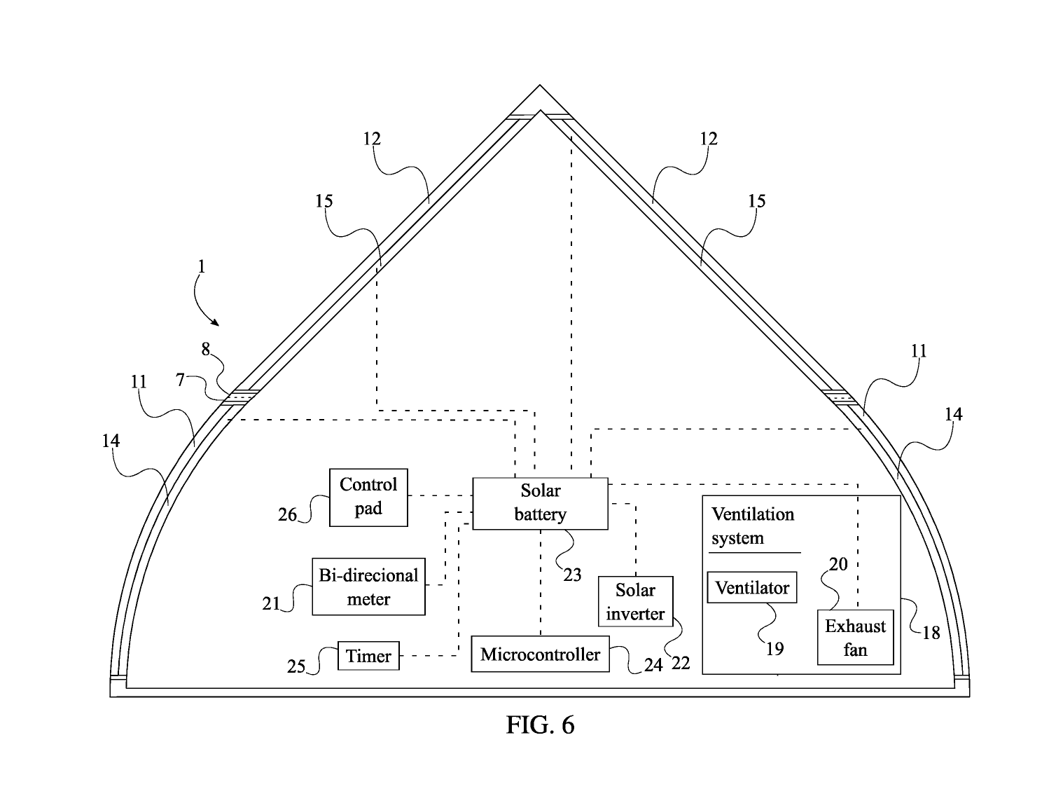

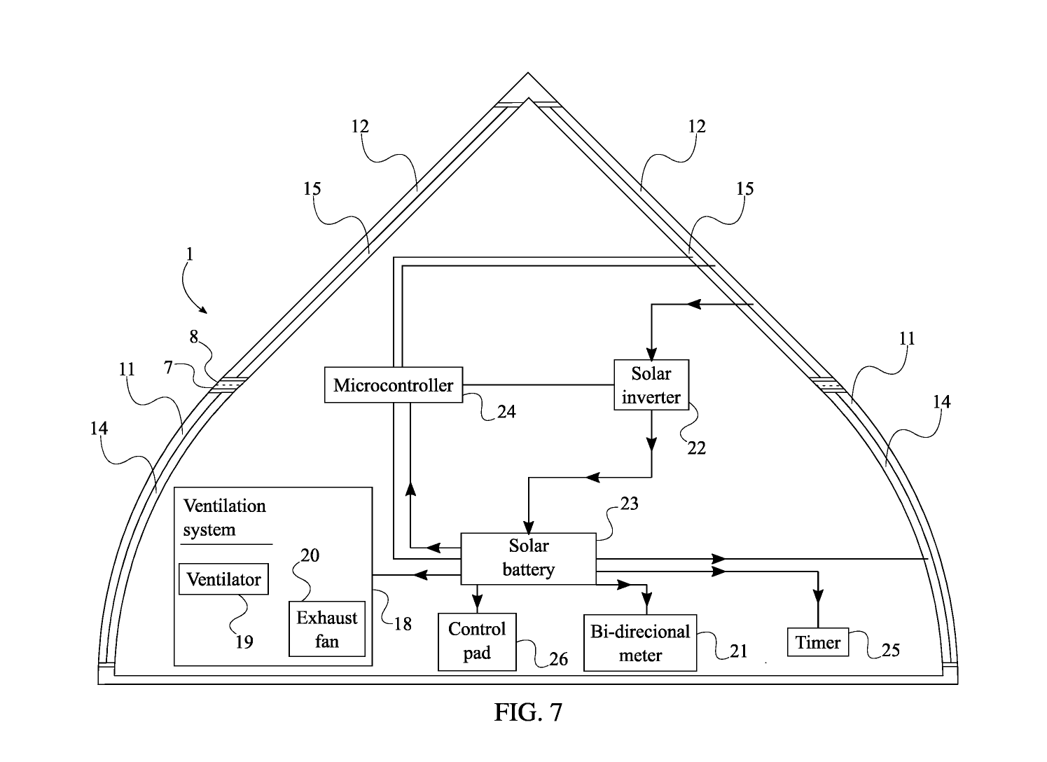

The present invention is a solar powered greenhouse that manipulates the passage of sunlight. The present invention is not susceptible to growing seasons, providing a user with more control and consistent production. In order for the present invention to increase overall production of a variety of plants, the present invention comprises a housing 1, at least one photovoltaic glass layer 10, at least one adjustable-opacity panel 13, a solar inverter 22, a solar battery 23, a microcontroller 24, and a control pad 26, shown in FIG. 1, FIG. 5, FIG. 6, and FIG. 7. The housing 1 surrounds and protects a variety of plants. Moreover, the housing 1 provides a controlled and a desired environment for a variety of plants. The housing 1 comprises at least one frame 2, a lateral wall 7, and a roof 8. The at least one frame 2 positions and upholds the at least one photovoltaic glass layer 10 and at least one adjustable-opacity panel 13. Together, the lateral wall 7 and the roof 8 define an enclosed environment for a variety of plants. In the preferred embodiment of the present invention, the lateral wall 7 and the roof 8, together, comprise a circular cross-section, in order to receive the maximum amount of direct sunlight. The at least one photovoltaic glass layer 10 collects most of the sunlight directed at the at least one photovoltaic glass layer 10 and converts the sunlight into electricity. In alternate embodiments of the present invention, a USB port is integrated into the at least one photovoltaic glass layer 10 so that electricity may be directly harnessed and distributed from the at least one photovoltaic glass layer 10. The remainder of the sunlight directed at the at least one photovoltaic glass layer 10 traverses through the at least one photovoltaic layer, and consequently through the at least one adjustable-opacity panel 13, and onto the variety of plants within the housing 1. The at least one adjustable-opacity panel 13 is preferably electro-chromatic glass that controls the emission of sunlight for the variety of plants within the housing 1. The interior environment of the housing 1 is able to create a sunlight-free environment for the variety of plants within the housing with the at least one adjustable-opacity panel 13. The solar inverter 22 converts the sunlight into electricity. More specifically, the solar inverter 22 converts direct current (DC) electricity into alternating current (AC) electricity. The solar battery 23 stores the converted electricity and distributes the electricity accordingly. Moreover, the stored energy is harnessed by connected pumps, HVAC units, supplemental lighting, and so on. The microcontroller 24 manages the electronic commands and controls as manually inputted by a user with the control pad 26.

The overall configuration of the aforementioned components safely and effectively provides a controlled environment for a variety of plants as the roof 8 is positioned adjacent the lateral wall 7 and is perimetrically mounted onto the lateral wall 7, shown in FIG. 1. In order for sunlight to enter the housing 1, the at least one frame 2 is integrated into the housing 1. Moreover, the at least one photovoltaic glass layer 10 is positioned adjacent and traverses across the at least one adjustable-opacity panel 13. In order for most of the sunlight directed against the housing 1 to be collected for energy, the at least one photovoltaic glass layer 10 is positioned adjacent an outer surface 27 of the housing 1. An inner surface 28 of the housing 1 is positioned opposite the outer surface 27 of the housing 1. The at least one photovoltaic glass layer 10 and the at least one adjustable-opacity panel 13 are mounted within the at least one frame 2, preserving the controlled environment within the housing 1. In order to control the distribution of energy to variety of electronic devices, the microcontroller 24 is electronically connected to the at least one photovoltaic glass layer 10, the at least one adjustable-opacity panel 13, the solar inverter 22, the solar battery 23, and the control pad 26. The present invention supplies an energy storage as the solar battery 23 is electrically connected to the microcontroller 24, the at least one adjustable-opacity panel 13, the solar inverter 22, and the control pad 26. More specifically, the sunlight collected by the at least one photovoltaic glass layer 10 and converts sunlight into electricity. As seen in FIG. 7, the electricity from the at least one photovoltaic layer is converted by the solar inverter 22 into AC electricity. The AC electricity is stored in the solar battery 23 and is harnessed by connected electronic devices and mechanisms from the solar battery 23. The electricity that is applied to the at least one adjustable-opacity panel 13 in order to turn the transparency of the at least one adjustable-opacity panel 13 opaque is harnessed from the solar battery 23 as well and controlled by the microcontroller 24.

As shown in FIG. 1, the housing 1 further comprises at least one door 9, thereby allowing a user to enter the housing 1. The at least one door 9 is integrated into the lateral wall 7. The at least one door 9 allows a user to access the variety of plants within the housing 1.

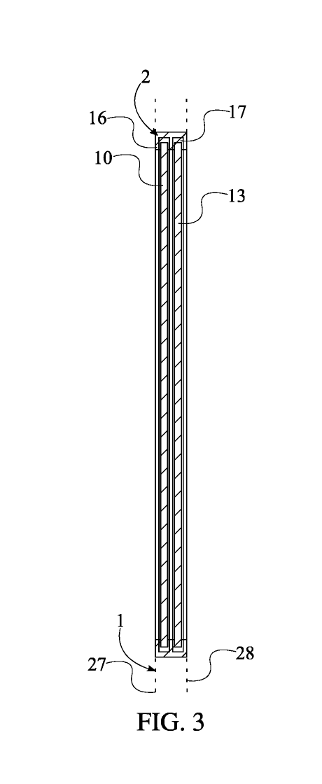

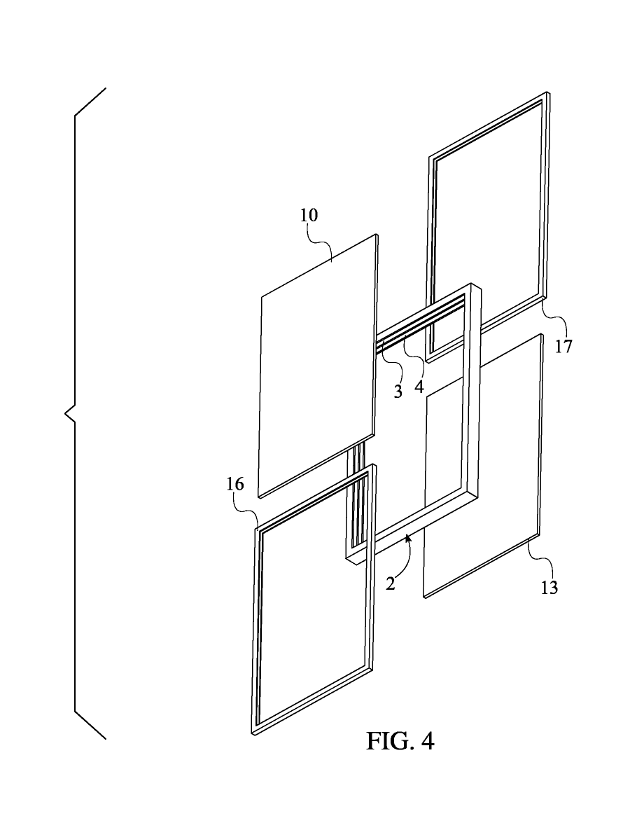

In order to maintain the desired control environment within the housing 1, the present invention comprises at least one first gasket 16 and at least one second gasket 17, shown in FIG. 3 and FIG. 4. In the preferred embodiment of the present invention the at least one first gasket 16 and the at least one second gasket 17 comprises silicone. Moreover, the at least one frame 2 comprises a first slot 3 and a second slot 4, seen in FIG. 4. The at least one first gasket 16 seals the at least one photovoltaic glass layer 10 within the first slot 3. Similarly, the at least one second gasket 17 seals the at least one adjustable-opacity panel 13 within the second slot 4. The first slot 3 and the second slot 4 position the at least one photovoltaic glass layer 10 and the at least one adjustable-opacity panel 13 with each other. Moreover, the first slot 3 and the second slot 4 integrate the at least one photovoltaic glass layer 10 and the at least one adjustable-opacity panel 13 into the housing 1. The first slot 3 is positioned adjacent the second slot 4 and is positioned parallel with the second slot 4. The at least one first gasket 16 eliminates leaks between the at least one photovoltaic glass layer 10 and the first slot 3 as the at least one first gasket 16 perimetrically traverses around the at least one photovoltaic glass layer 10. Similarly, the at least one second gasket 17 eliminates leaks between the at least on adjustable-opacity panel and the second slot 4 as the at least one second gasket 17 perimetrically traverses around the at least one adjustable-opacity panel 13. The at least one photovoltaic glass layer 10 is mounted within the first slot 3 with the at least one first gasket 16. Similarly, the at least one adjustable-opacity panel 13 is mounted within the second slot 4 with the at least one second gasket 17.

In the preferred embodiment of the present invention, the at least one frame 2 comprises a plurality of first frames 5, shown in FIG. 5, FIG. 6, and FIG. 7. In order to accommodate the plurality of first frames 5, the at least one photovoltaic glass layer 10 comprises a plurality of first photovoltaic glass layers 11, and the at least one adjustable-opacity panel 13 comprises a plurality of first adjustable-opacity panels 14. Each of the plurality of first frames 5 positions a corresponding first photovoltaic glass layer of the plurality of first photovoltaic glass layers 11 and a corresponding first adjustable-opacity panels of the plurality of first adjustable-opacity panels 14 into the lateral wall 7 of the housing 1. Moreover, the plurality of first frames 5 is distributed across the lateral wall 7. Each first photovoltaic glass layer of the plurality of first photovoltaic glass layers 11 and each first adjustable-opacity panel of the plurality of the first adjustable-opacity panels 14 are mounted within a corresponding first frame of the plurality of first frames 5.

In the preferred embodiment of the present invention, the collection of sunlight is maximized across the entirety of the housing 1 as the at least one frame 2 comprises a plurality of second frames 6, shown in FIG. 5, FIG. 6, and FIG. 7. In order to accommodate the plurality of second frames 6, the at least one photovoltaic glass layer 10 comprises a plurality of second photovoltaic glass layers 12, and the at least one adjustable-opacity panel 13 comprises a plurality of second adjustable-opacity panels 15. Each of the plurality of second frames 6 positions a corresponding second photovoltaic glass layer of the plurality of second photovoltaic glass layers 12 and a corresponding second adjustable-opacity panels of the plurality of second adjustable-opacity panels 15 into the roof 8 of the housing 1. Moreover, the plurality of second frames 6 is distributed across the roof 8. Each second photovoltaic glass layer of the plurality of second photovoltaic glass layers 12 and each second adjustable-opacity panel of the plurality of the second adjustable-opacity panels 15 are mounted within a corresponding second frame of the plurality of second frames 6.

The present invention further comprises a ventilation system 18 in order to effectively sustains a variety of plants within the housing 1. The ventilation system 18 comprises a ventilator 19 and an exhaust fan 20, also shown in FIG. 5, FIG. 6, and FIG. 7. The ventilator 19 allows for a path of fresh air from the surrounding environment to flow into and out of the housing 1. The exhaust fan 20 facilitates the flow of fresh air into and out of the housing 1 through the ventilator 19. The ventilator 19 is integrated into the roof 8 so that the variety of plants within the housing 1 remain protected with the lateral wall 7, preventing small and unwanted animals from entering the housing 1. The exhaust fan 20 is positioned within the housing 1, thereby directing the flow of fresh air into and out of the housing 1. The exhaust fan 20 may be mounted to the roof 8 or the lateral wall 7, such that the variety of plants are not damaged by the exhaust fan 20. The microcontroller 24 is electronically connected to the exhaust fan 20 so that the exhaust fan 20 may be controlled by the user with the control pad 26. The exhaust fan 20 receives the necessary power as the solar battery 23 is electrically connected to the exhaust fan 20. In alternate embodiments of the present invention, the ventilator 19 may comprise a plurality of panels that is rotatable with motor. The microcontroller 24 is electronically connected to the motor and the solar battery 23 is electrically connected to the motor. This arrangement allows a user to open and close the ventilator 19 in this alternate embodiment.

In order to maintain the safety of the present invention, and more specifically the solar inverter 22 and the solar battery 23, the present invention further comprises a bi-directional meter 21 and a timer 25, shown in FIG. 5, FIG. 6, and FIG. 7. The bi-directional meter 21 measures the flow, usage, and a variety of other factors relating to the collection and conversion of sunlight. The timer 25 determines the amount of time for the collection of sunlight and the usage of power from the solar battery 23. The microcontroller 24 is electronically connected to the bi-directional meter 21 and the timer 25. The control pad 26 preferably comprises a display screen that allows the control pad 26 to visually display readings and outputs. The bi-directional meter 21 and the timer 25 receive necessary power to operate as the solar battery 23 is electrically connected to the bi-directional meter 21 and the timer 25.

Although the invention has been explained in relation to its preferred embodiment, it is to be understood that many other possible modifications and variations can be made without departing from the spirit and scope of the invention as hereinafter claimed.

What is claimed is:

1. A solar powered greenhouse comprises:
a housing;
at least one photovoltaic glass layer;
at least one adjustable-opacity panel;
a solar inverter;
a solar battery;
a microcontroller;
a control pad;
the housing comprises at least one frame, a lateral wall, and a roof;
the roof being positioned adjacent the lateral wall;
the roof being perimetrically mounted onto the lateral wall;
the at least one frame being integrated into the housing;
the at least one photovoltaic glass layer being positioned adjacent and traversing across the at least one adjustable-opacity panel;
the at least one photovoltaic glass layer being positioned adjacent an outer surface of the housing;
an inner surface of the housing being positioned opposite the outer surface of the housing;
the at least one photovoltaic glass layer and the at least one adjustable-opacity panel being mounted within the at least one frame;
the microcontroller being electronically connected to the at least one photovoltaic glass layer, the at least one adjustable-opacity panel, the solar inverter, the solar battery, and the control pad; and,
the solar battery being electrically connected to the microcontroller, the at least one adjustable-opacity panel, the solar inverter, and the control pad.

2. The solar powered greenhouse as claimed as claim 1 comprises:
the housing further comprises at least one door; and,
the at least one door being integrated into the lateral wall.

3. The solar powered greenhouse as claimed as claim 1 comprises:
at least one first gasket;
at least one second gasket;
the at least one frame comprises a first slot and a second slot;
the first slot being positioned adjacent the second slot;
the first slot being positioned parallel with the second slot;
the at least one first gasket perimetrically traversing around the at least one photovoltaic glass layer;
the at least one second gasket perimetrically traversing around the at least one adjustable-opacity panel;
the at least one photovoltaic glass layer being mounted within the first slot with the at least one first gasket; and,
the at least one adjustable-opacity panel being mounted within the second slot with the at least one second gasket.

4. The solar powered greenhouse as claimed as claim 1 comprises:
the at least one frame comprises a plurality of first frames;
the at least one photovoltaic glass layer comprises a plurality of first photovoltaic glass layers;
the at least one adjustable-opacity panel comprises a plurality of first adjustable-opacity panels;
the plurality of first frames being distributed across the lateral wall; and,
each first photovoltaic glass layer and each first adjustable-opacity panel being mounted within a corresponding first frame.

5. The solar powered greenhouse as claimed as claim 1 comprises:
the at least one frame comprises a plurality of second frames;
the at least one photovoltaic glass layer comprises a plurality of second photovoltaic glass layers;
the at least one adjustable-opacity panel comprises a plurality of second adjustable-opacity panels;
the plurality of second frames being distributed across the roof; and,
each second photovoltaic glass layer and each second adjustable-opacity panel being mounted within a corresponding second frame.

6. The solar powered greenhouse as claimed as claim 1 comprises:
a ventilation system;
the ventilation system comprises a ventilator and an exhaust fan;
the ventilator being integrated into the roof;
the exhaust fan being positioned within the housing;
the microcontroller being electronically connected to the exhaust fan; and,
the solar battery being electrically connected to the exhaust fan.

7. The solar powered greenhouse as claimed as claim 1 comprises:
a bi-directional meter;
a timer;
the microcontroller being electronically connected to the bi-directional meter and the timer; and,
the solar battery being electrically connected to the bi-directional meter and the timer.

8. A solar powered greenhouse comprises:
a housing;
at least one photovoltaic glass layer;
at least one adjustable-opacity panel;
a solar inverter;
a solar battery;
a microcontroller;
a control pad;
at least one first gasket;
at least one second gasket;
the housing comprises at least one frame, a lateral wall, and a roof;
the at least one frame comprises a first slot and a second slot;
the roof being positioned adjacent the lateral wall;
the roof being perimetrically mounted onto the lateral wall;
the at least one frame being integrated into the housing;
the at least one photovoltaic glass layer being positioned adjacent and traversing across the at least one adjustable-opacity panel;
the at least one photovoltaic glass layer being positioned adjacent an outer surface of the housing;
an inner surface of the housing being positioned opposite the outer surface of the housing;
the at least one photovoltaic glass layer and the at least one adjustable-opacity panel being mounted within the at least one frame;
the microcontroller being electronically connected to the at least one photovoltaic glass layer, the at least one adjustable-opacity panel, the solar inverter, the solar battery, and the control pad;
the solar battery being electrically connected to the microcontroller, the at least one adjustable-opacity panel, the solar inverter, and the control pad;
the first slot being positioned adjacent the second slot;
the first slot being positioned parallel with the second slot;
the at least one first gasket perimetrically traversing around the at least one photovoltaic glass layer;
the at least one second gasket perimetrically traversing around the at least one adjustable-opacity panel;
the at least one photovoltaic glass layer being mounted within the first slot with the at least one first gasket; and,
the at least one adjustable-opacity panel being mounted within the second slot with the at least one second gasket.

9. The solar powered greenhouse as claimed as claim 8 comprises:
the housing further comprises at least one door; and,
the at least one door being integrated into the lateral wall.

10. The solar powered greenhouse as claimed as claim 8 comprises:
the at least one frame comprises a plurality of first frames;
the at least one frame comprises a plurality of second frames;
the at least one photovoltaic glass layer comprises a plurality of first photovoltaic glass layers;
the at least one photovoltaic glass layer comprises a plurality of second photovoltaic glass layers;
the at least one adjustable-opacity panel comprises a plurality of first adjustable-opacity panels;
the plurality of first frames being distributed across the lateral wall;
each first photovoltaic glass layer and each first adjustable-opacity panel being mounted within a corresponding first frame;
the plurality of second frames being distributed across the roof; and,
each second photovoltaic glass layer and each second adjustable-opacity panel being mounted within a corresponding second frame.

11. The solar powered greenhouse as claimed as claim 8 comprises:
a ventilation system;
the ventilation system comprises a ventilator and an exhaust fan;
the ventilator being integrated into the roof;
the exhaust fan being positioned within the housing;
the microcontroller being electronically connected to the exhaust fan; and,
the solar battery being electrically connected to the exhaust fan.

12. The solar powered greenhouse as claimed as claim 8 comprises:
a bi-directional meter;
a timer;
the microcontroller being electronically connected to the bi-directional meter and the timer; and,
the solar battery being electrically connected to the bi-directional meter and the timer.

13. A solar powered greenhouse comprises:
a housing;
at least one photovoltaic glass layer;
at least one adjustable-opacity panel;
a solar inverter;
a solar battery;
a microcontroller;
a control pad;
a ventilation system;
the housing comprises at least one frame, a lateral wall, and a roof;
the ventilation system comprises a ventilator and an exhaust fan;
the roof being positioned adjacent the lateral wall;
the roof being perimetrically mounted onto the lateral wall;
the at least one frame being integrated into the housing;
the at least one photovoltaic glass layer being positioned adjacent and traversing across the at least one adjustable-opacity panel;
the at least one photovoltaic glass layer being positioned adjacent an outer surface of the housing;
an inner surface of the housing being positioned opposite the outer surface of the housing;
the at least one photovoltaic glass layer and the at least one adjustable-opacity panel being mounted within the at least one frame;
the microcontroller being electronically connected to the at least one photovoltaic glass layer, the at least one adjustable-opacity panel, the solar inverter, the solar battery, and the control pad;
the solar battery being electrically connected to the microcontroller, the at least one adjustable-opacity panel, the solar inverter, and the control pad;
the ventilator being integrated into the roof;
the exhaust fan being positioned within the housing;
the microcontroller being electronically connected to the exhaust fan; and,
the solar battery being electrically connected to the exhaust fan.

14. The solar powered greenhouse as claimed as claim 13 comprises:
the housing further comprises at least one door; and,
the at least one door being integrated into the lateral wall.

15. The solar powered greenhouse as claimed as claim 13 comprises:
at least one first gasket;
at least one second gasket;
the at least one frame comprises a first slot and a second slot;
the first slot being positioned adjacent the second slot;
the first slot being positioned parallel with the second slot;
the at least one first gasket perimetrically traversing around the at least one photovoltaic glass layer;
the at least one second gasket perimetrically traversing around the at least one adjustable-opacity panel;
the at least one photovoltaic glass layer being mounted within the first slot with the at least one first gasket; and,
the at least one adjustable-opacity panel being mounted within the second slot with the at least one second gasket.

16. The solar powered greenhouse as claimed as claim 13 comprises:
the at least one frame comprises a plurality of first frames;
the at least one photovoltaic glass layer comprises a plurality of first photovoltaic glass layers;
the at least one adjustable-opacity panel comprises a plurality of first adjustable-opacity panels;
the plurality of first frames being distributed across the lateral wall; and,
each first photovoltaic glass layer and each first adjustable-opacity panel being mounted within a corresponding first frame.

17. The solar powered greenhouse as claimed as claim 13 comprises:
the at least one frame comprises a plurality of second frames;
the at least one photovoltaic glass layer comprises a plurality of second photovoltaic glass layers;
the at least one adjustable-opacity panel comprises a plurality of second adjustable-opacity panels;
the plurality of second frames being distributed across the roof; and,
each second photovoltaic glass layer and each second adjustable-opacity panel being mounted within a corresponding second frame.

18. The solar powered greenhouse as claimed as claim 13 comprises:
a bi-directional meter;
a timer;
the microcontroller being electronically connected to the bi-directional meter and the timer; and,
the solar battery being electrically connected to the bi-directional meter and the timer.
